(19) United States
(12) Patent Application Publication
(10) Pub. No.: US 2026/0278630 A1
(43) Pub. Date: Sep. 17, 2026

(54) CORRELATION-ENHANCED OBJECTIVE FUNCTION FOR IMPROVED MACHINE LEARNING-BASED ENERGY FORECASTING

(71) Applicant: HANWHA SOLUTIONS CORPORATION, Seoul (KR)

(72) Inventor: Mohammad Amin KHODKAR, Santa Clara, CA (US)

(73) Assignee: HANWHA SOLUTIONS CORPORATION, Seoul (KR)

(21) Appl. No.: 19/079,763

(22) Filed: Mar. 14, 2025

(51) Int. Cl. G06Q 30/0201; G06Q 50/06; H02J 3/00

(52) U.S. Cl. CPC G06Q 30/0206; G06Q 50/06; H02J 3/003

(57) ABSTRACT

A computing device may include a memory having computer readable instructions stored thereon, and processing circuitry configured to execute the computer readable instructions to, obtain historical energy data, generate a correlation-enhanced energy forecast using a machine learning model based on the historical energy data, and output energy storage recommendation information corresponding to a desired future time period based on the correlation-enhanced energy forecast.

### BACKGROUND

One or more example embodiments relate to a correlation-enhanced objective function for improved machine-learning-based energy forecasting, apparatuses for performing the improved machine-learning-based energy forecasting, systems including the same, methods of operating the same, and/or non-transitory computer readable media including computer readable instructions for performing the improved machine-learning-based energy forecasting.

Various energy marketplaces, such as Electric Reliability Council of Texas (ERCOT), California Independent System Operator (CAISO), etc., exist which allow utility companies, private energy generation companies, energy storage system operators, homeowners, etc., to connect to the electrical grid for a community and buy or sell energy through the energy marketplace. Prices for energy purchased or sold through the energy marketplace may fluctuate based on several factors, such as energy generation rates, energy consumption rates, the weather, or the like.

### SUMMARY

At least one example embodiment relates to a computing device.

In at least one example embodiment, the computing device may include memory having computer readable instructions stored thereon, and processing circuitry configured to execute the computer readable instructions to, obtain historical energy data, generate a correlation-enhanced energy forecast using a machine learning model based on the historical energy data, and output energy storage recommendation information corresponding to a desired future time period based on the correlation-enhanced energy forecast.

Some example embodiments provide that the processing circuitry is further configured to execute the computer readable instructions to output the energy storage recommendation information to an energy storage system, the energy storage recommendation information enabling the energy storage system to adjust energy storage levels corresponding to the desired future time period.

Some example embodiments provide that the processing circuitry is further configured to execute the computer readable instructions to output the energy storage recommendation information to a power generation system, the energy storage recommendation information enabling the power generation system to adjust energy production levels corresponding to the desired future time period.

Some example embodiments provide that the historical energy data includes at least one of: system-level energy demand forecast information, zonal-level energy demand forecast information, system-level renewable energy generation forecast, net load information, historical energy price information, zonal weather forecast information, persistence term information, seasonality information, or any combinations thereof.

Some example embodiments provide that the historical energy data includes historical energy price data, and the machine learning model is further configured to generate the correlation-enhanced energy forecast by forecasting future energy prices for the desired future time period based on the historical energy price data for at least one historical time period.

Some example embodiments provide that the machine learning model is further configured to generate the correlation-enhanced energy forecast by, determining an energy price prediction error based on a previous energy price prediction for the at least one historical time period and the historical energy price data for at least one historical time period, determining a correlation error based on the energy price prediction error and a relative direction of the energy price prediction and the actual energy price, and adjusting at least one weight or parameter of the machine learning model based on the energy price prediction error and the correlation error.

Some example embodiments provide that the processing circuitry is further configured to execute the computer readable instructions to train the machine learning model using a gradient-boosted decision tree algorithm.

At least one example embodiment is related to an energy storage system.

In at least one example embodiment, the energy storage system may include, an energy storage system connected to an energy grid, memory having computer readable instructions stored thereon, and processing circuitry configured to execute the computer readable instructions to, obtain historical energy data associated with the energy grid, generate a correlation-enhanced energy forecast using a machine learning model based on the historical energy data, and determine energy storage recommendation information corresponding to a desired future time period based on the correlation-enhanced energy forecast.

Some example embodiments provide that the processing circuitry is further configured to execute the computer readable instructions to adjust energy storage levels of the energy storage system corresponding to the desired future time period based on the energy storage recommendation information.

Some example embodiments provide that the energy storage recommendation information includes an energy price prediction corresponding to the desired future time period, and the processing circuitry is further configured to execute the computer readable instructions to adjust the energy storage levels of the energy storage system by increasing output of energy from the energy storage system to the energy grid based on the predicted energy price and a desired price threshold.

Some example embodiments provide that the processing circuitry is further configured to execute the computer readable instructions to adjust the energy storage levels of the energy storage system by increasing storage of energy in the energy storage system based on the energy price prediction and the desired price threshold.

Some example embodiments provide that the system further includes a power generation system configured to generate energy, and the processing circuitry is further configured to execute the computer readable instructions to adjust energy production levels of the power generation system corresponding to the desired future time period based on the energy storage recommendation information.

Some example embodiments provide that the energy storage recommendation information includes an energy price prediction corresponding to the desired future time period, and the processing circuitry is further configured to execute the computer readable instructions to adjust the energy production levels of the power generation system by controlling the power generation system based on the energy price prediction and a desired price threshold such that the power generation system outputs the generated energy to the energy grid.

Some example embodiments provide that the historical energy data includes at least one of: system-level energy demand forecast information, zonal-level energy demand forecast information, system-level renewable energy generation forecast, net load information, historical energy price information, zonal weather forecast information, persistence term information, seasonality information, or any combinations thereof.

Some example embodiments provide that the historical energy data includes historical energy price data, and the machine learning model is further configured to generate the correlation-enhanced energy forecast by forecasting future energy prices for the desired future time period based on the historical energy price data for at least one historical time period.

Some example embodiments provide that the machine learning model is further configured to generate the correlation-enhanced energy forecast by, determining an energy price prediction error based on a previous energy price prediction for the at least one historical time period and the historical energy price data for at least one historical time period, determining a correlation error based on the energy price prediction error and a relative direction of the energy price prediction and the actual energy price, and adjusting at least one weight or parameter of the machine learning model based on the energy price prediction error and the correlation error.

Some example embodiments provide that the processing circuitry is further configured to execute the computer readable instructions to train the machine learning model using a gradient-boosted decision tree algorithm.

At least one example embodiment is related to a method of operating a computing device.

In at least one example embodiment, the method may include, obtaining historical energy data, generating a correlation-enhanced energy forecast using a machine learning model based on the historical energy data, and outputting energy storage recommendation information corresponding to a desired future time period based on the correlation-enhanced energy forecast.

Some example embodiments provide that the method may further include outputting the energy storage recommendation information to an energy storage system, the energy storage recommendation information enabling the energy storage system to adjust energy storage levels corresponding to the desired future time period, or outputting the energy storage recommendation information to a power generation system, the energy storage recommendation information enabling the power generation system to adjust energy production levels corresponding to the desired future time period.

Some example embodiments provide that the historical energy data includes historical energy price data, and the generating the correlation-enhanced energy forecast includes, forecasting future energy prices for the desired future time period based on the historical energy price data for at least one historical time period, determining an energy price prediction error based on a previous energy price prediction for the at least one historical time period and the historical energy price data for at least one historical time period, determining a correlation error based on the energy price prediction error and a relative direction of the energy price prediction and the actual energy price, and adjusting at least one weight or parameter of the machine learning model based on the energy price prediction error and the correlation error.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates an example system for performing a machine-learning-based energy forecasting according to at least one example embodiment;

FIG. 2 is a block diagram illustrating an example computing device according to at least one example embodiment;

FIG. 3 is a flowchart depicting an example method of operating an energy forecasting machine-learning model; and

FIGS. 4A to 4B are graphs illustrating the performance of various energy forecast prediction models versus actual energy data according to at least one example embodiment.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory (ies) that work together to cause an apparatus, such as a mobile phone or server, to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Various example embodiments relate to at least one apparatus for providing correlation-enhanced objective function for improved machine-learning-based energy forecasting, systems including the same, methods of operating the same, and/or non-transitory computer readable media including computer readable instructions for performing the improved machine-learning-based energy forecasting.

In conventional energy forecasting systems, regression objective (loss) functions, such as Huber loss functions or Pinball loss functions, are used to generate energy forecasts. However, these regression objective functions are known to amplify or lessen the effects of outliers (e.g., spikes, etc.) seen in their data sets, such as spikes in energy prices caused by, for example, extreme weather, unexpected energy consumption demand, loss of expected energy generation capacity, energy transmission issues, etc. For example, a probabilistic prediction model based on the Pinball loss function may generate forecasts for a quantile of τ>0.5 which may overestimate or underestimate the actual values 100 τ% or 100 (1−τ) % of the times, respectively. Similarly, a prediction model based on the Huber loss function will generate forecasts which leverage a typical mean-squared-error (MSE) loss function when an error (e.g., the difference between the forecast and the ground truth) is small, but in a continuous fashion, changes the forecast to a loss function based on the mean absolute error (MAE) when the error is large, in order to reduce the effects of the outliers in the model.

Accordingly, there is a desire for improved energy forecasting using a machine-learning model which uses a correlation-enhanced objective function. More specifically, according to at least one example embodiment, a machine learning model which uses correlation-enhanced objective function may monitor the correlation and/or concurrency of directional variations between the predicted energy forecasts and the actual energy data values (e.g., determining whether both increase, decrease, or remain the same from a current time instance (tᵢ) to a subsequent time instance (tᵢ₊₁)) in order to provide improved energy forecasts, including improved predictions for peaks and troughs in energy demand, energy production, and/or energy prices, etc. Additionally, at least one example embodiment of the machine-learning model may provide energy production and/or storage recommendations for energy generators (e.g., utility companies, private energy generation companies, renewable energy providers, etc.) energy storage system (ESS) operators, homeowners, etc., based on the improved energy forecasts, thereby enabling the energy generators, ESS operators, homeowners, etc., to more efficiently adjust their energy storage levels, energy transmission levels, etc.

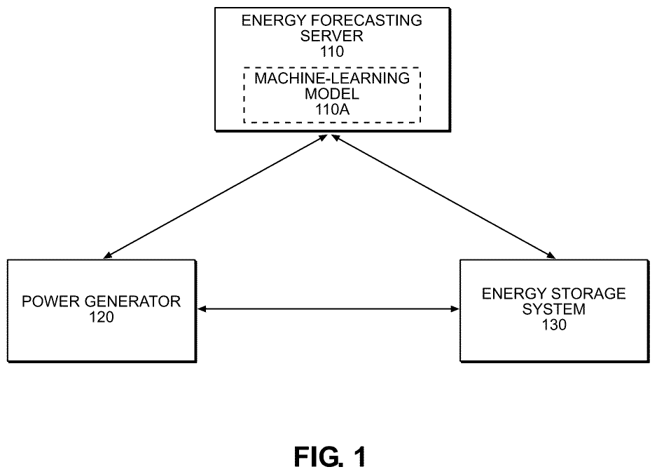

FIG. 1 illustrates an example system for performing a machine-learning-based energy forecasting according to at least one example embodiment.

According to at least one example embodiment, a machine-learning-based energy forecasting system 1000 may include at least one energy forecasting server 110, at least one power generator 120, and/or at least one energy storage system (ESS) 130, etc., but is not limited thereto. For example, the energy forecasting system 1000 may include a greater or lesser number of energy forecasting servers, power generators, ESSes, and/or additional components, such as residential renewable energy generators, residential battery systems, electrical connections to an electrical grid (e.g., public utility grid), energy sensors, utility meters, servers associated with an energy marketplace, client devices associated with operators of the power generator 120 and/or the ESS 130, client devices associated with the operators of residential renewable energy generators, residential battery systems, etc. According to at least one example embodiment, the energy forecasting server 110, the power generator 120, and/or the ESS 130 may each be connected to an electrical grid, and may also be connected over a wired network, such as a wired fiber optic network, a wired copper network, etc., and/or a wireless network, such as a cellular wireless access network (e.g., a 3G wireless access network, a 4G-Long Term Evolution (LTE) network, a 5G-New Radio (e.g., 5G) wireless network, a 6G network, a 7G network, a WiFi network, etc.), but the example embodiments are not limited thereto. Additionally, the energy forecasting server 110, the power generator 120, and/or the energy storage system (ESS) 130, etc., may be connected over a data network, such as the Internet, an intranet, a wide area network, and/or another type of network.

According to some example embodiments, the energy forecasting server 110 may be integrated with the power generator 120 and/or the ESS 130, but is not limited thereto. Additionally, the power generator 120 may be integrated with the ESS 130, etc., but the example embodiments are not limited thereto.

The energy forecasting server 110 may be a server and/or other computing device (e.g., personal computer, laptop, smartphone, tablet, etc.) and may be specially configured to and/or specially programmed to train and/or execute a machine-learning model 110A to perform energy forecasting based on a plurality of input data, such as historical, current, and/or future (e.g., predicted, forecasted, etc.) energy demand information, energy generation information, energy price information, and/or weather information, etc., but the example embodiments are not limited thereto. More specifically, the input data may include at least one of: system-level energy demand forecast information (e.g., market-level, grid-level energy demand forecasts, state-level demand forecasts, geographic region-level demand forecasts, etc.), zonal-level energy demand forecast information (e.g., a subset of market-level and/or grid-level energy demand forecasts, such as county-level forecasts, city-level forecasts, neighborhood-level forecasts, etc.), net load information (e.g., a difference between system-level energy demand level and the system-level energy generation level, etc.), system-level renewable energy generation forecast, historical energy price information, zonal weather forecast information (e.g., including the apparent temperature, etc.), persistence term information (e.g., energy prices of the day before, etc.), daily and annual seasonality information (e.g., information indicating an hour of the day or a day of the year during which the data was collected), or any combinations thereof. Additionally, one or more of the input data may include information pertaining to various time periods, for example, providing hourly information, daily information, weekly information, monthly information, quarterly information, yearly information, etc.

The energy forecasting server 110 may train the machine-learning model 110A such that the machine-learning model calculates and/or predicts future energy forecasts for a desired geographical area for a desired future time period based on the received energy input data. The future energy forecast information may include predicted energy demand information, including peaks and/or troughs in the predicted energy demands over the desired future time period, predicted energy generation information, predicted energy consumption information, and/or predicted energy prices for the desired future period of time, including peaks and troughs of the energy prices over the desired future time period, etc., but the example embodiments are not limited thereto.

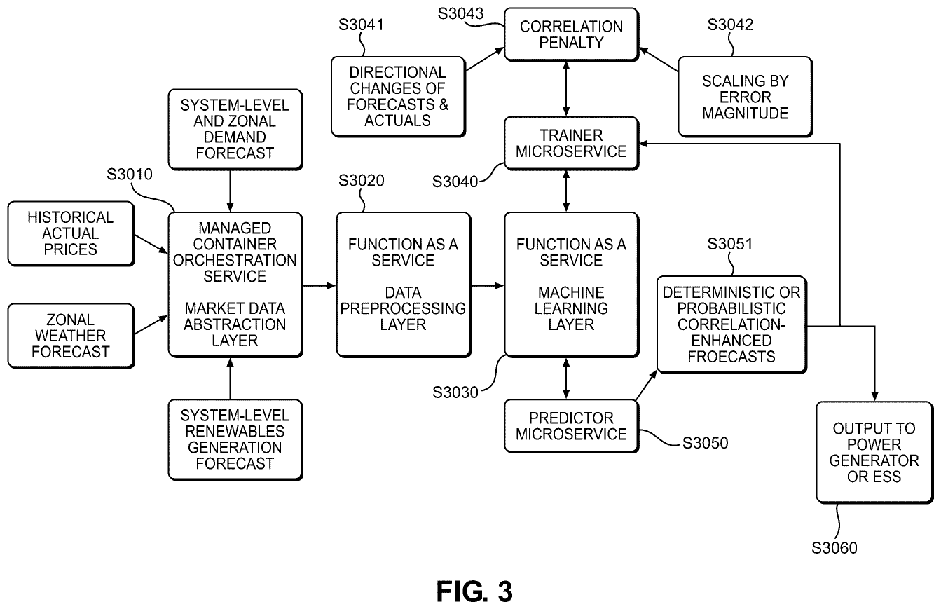

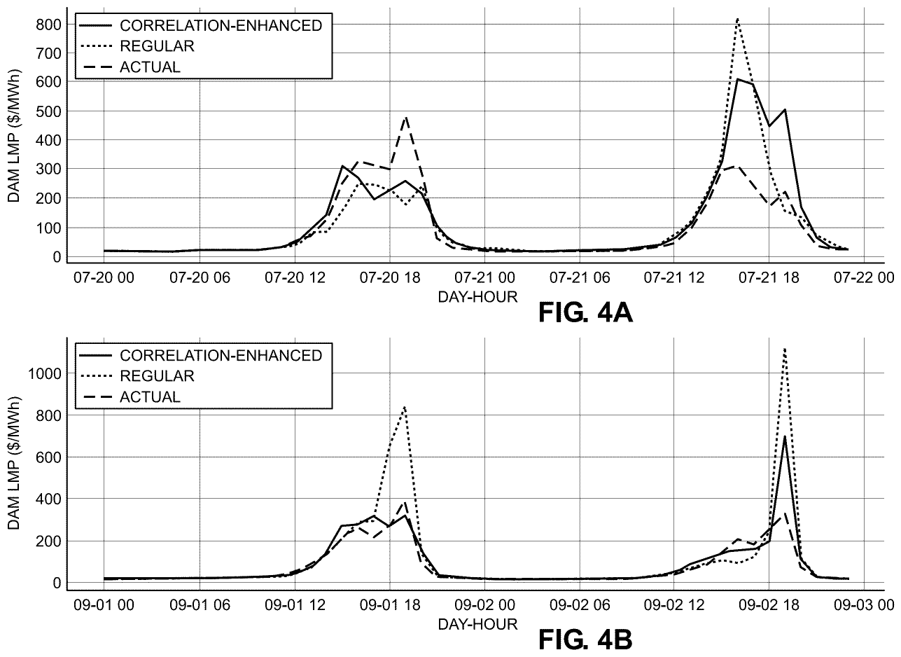

Additionally, the machine-learning model 110A may generate recommendations for the power generator 120 and/or the ESS 130 based on the future energy forecast information, but is not limited thereto, and for example, may also generate recommendations for the residential renewable energy generators, residential battery systems, etc. The recommendations may include recommendations and/or instructions to the power generator 120 regarding adjustments (e.g., increasing, decreasing, and/or maintaining, etc.) to the amount of energy to generate and/or transmit to the electrical grid, energy marketplace, etc., recommendations and/or instructions to the power generator 120 regarding the timing of the generation and/or transmission of the energy, recommendations and/or instructions regarding adjustments to the energy production capacity of the power generator 120 (e.g., increasing, decreasing, and/or maintaining the number of solar panels, wind turbines, water turbines, etc., increasing, decreasing, and/or maintaining the hours of operation of a fossil fuel power plant and/or nuclear reactor, etc.), but is not limited thereto. Further, the machine-learning model 110A may generate recommendations and/or instructions to the ESS 130 regarding adjustments (e.g., increasing, decreasing, and/or maintaining, etc.) to the amount of energy to store in its batteries and/or adjustments to the amount of energy to transmit to the electrical grid and/or energy marketplace, recommendations and/or instructions to the ESS 130 regarding the timing of the storage and/or transmission of the energy, recommendations and/or instructions regarding adjustments to the energy storage capacity of the ESS 130 (e.g., increasing, decreasing, and/or maintaining the number of storage batteries, etc.), but is not limited thereto. The training and operation of the machine-learning model 110A will be discussed in greater detail in connection with FIGS. 3 to 4B.

According to at least one example embodiment, the power generator 120 may be an energy generation utility and/or a private energy generation company which generates and supplies energy to the ESS 130, the energy marketplace, and/or the electrical grid, etc. For example, the power generator 120 may be at least one of a renewable energy power generator, such as a solar power plant, a wind power plant, a hydroelectric power plant, a tidal power plant, a geothermal power plant, etc., a fossil fuel power generator, e.g., a coal-fired power plant, a diesel-fired power plant, a gas-fired power plant, etc., and/or a nuclear power plant, but the example embodiments are not limited thereto.

The power generator 120 may further include at least one computing device, such as a PC, laptop, server, mainframe, smart device, etc., to control the operations of the power generator and to communicate with the energy forecasting server 110, the ESS 130, the energy marketplace, the electrical grid, and/or customer computing devices, etc. For example, the computing device of the power generator 120 may receive recommendations and/or instructions from the energy forecasting server 110 regarding the scheduling of energy production and/or transmission of energy to the ESS 130, the electrical grid and/or the energy marketplace, etc., but is not limited thereto.

According to at least one example embodiment, the ESS 130 may generate and/or receive energy and store the generated and/or received energy in energy storage devices, such as batteries, capacitors, super capacitors, super-conducting magnetic storage, as pumped hydroelectricity storage, in compressed-air energy storage, flywheel energy storage, thermal energy storage, converted to hydrogen fuel cells, etc., but the example embodiments are not limited thereto. In some example embodiments, the ESS 130 may include and/or may be co-located with a power generator which is used to generate energy to be stored in the energy storage device of the ESS 130 and/or may receive energy from the power generator 120, etc. The ESS 130 may be used for load balancing and/or energy usage shifting purposes, or in other words, the ESS 130 may transmit stored energy to the energy marketplace and/or the electrical grid, etc., when system-level energy demand increases, when system-level energy production levels are decreased (e.g., during times when renewable energy production is decreased, when power generators are offline, when there are issues with power transmission lines, etc.), when system-level energy prices are increased, etc. The ESS 130 may store energy when system-level energy demand decreases, when system-level energy production levels are increased, when system-level energy prices are decreased, etc. The ESS 130 may further include at least one computing device, such as a PC, laptop, server, mainframe, etc., to control the operations of the ESS and to communicate with the energy forecasting server 110, the power generator 120, the energy marketplace, the electrical grid, and/or customer computing devices, etc. For example, the computing device of the ESS 130 may receive recommendations and/or instructions from the energy forecasting server 110 regarding the scheduling of energy storage and/or transmission of energy to the electrical grid and/or the energy marketplace, etc., but is not limited thereto.

While certain components of a machine-learning-based energy forecasting system are shown in FIG. 1, the example embodiments are not limited thereto, and the machine-learning-based energy forecasting system may include components other than those shown in FIG. 1, which are desired, necessary, and/or beneficial for operation of the underlying energy forecasting system, energy generation and/or storage system, and/or electrical system, such as monitoring equipment, communication equipment, etc.

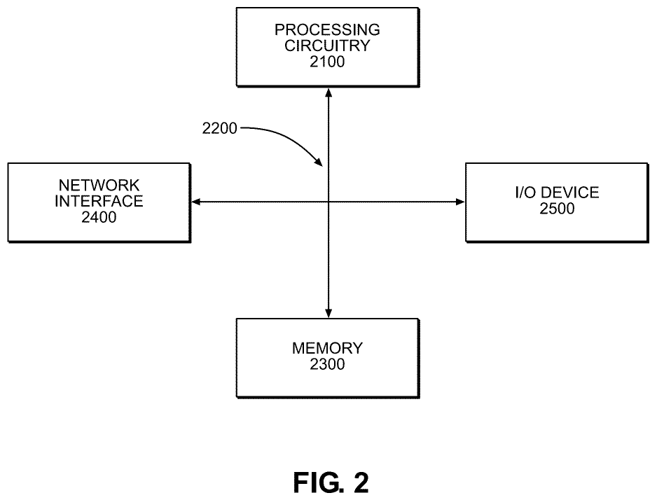

FIG. 2 illustrates an example computing device according to at least one example embodiment. The example computing device 2000 of FIG. 2 may correspond to the energy forecasting server 110, at least one computing device included in the power generator 120, and/or at least one computing device included in the ESS 130 of FIG. 1, but the example embodiments are not limited thereto, and the computing device(s) may employ alternative architectures, etc.

Referring to FIG. 2, a computing device 2000 (e.g., server, PC, laptop, smart device, tablet, etc.) may include processing circuitry 2100, at least one communication bus 2200, a memory 2300, at least one network interface 2400, and/or at least one input/output (I/O) device 2500 (e.g., a keyboard, a touchscreen, a mouse, a microphone, a camera, a speaker, a monitor, a touchscreen, etc.), but the example embodiments are not limited thereto. According to some example embodiments, the computing device 2000 may include a greater or lesser number of constituent components, and for example, the computing device 2000 may also include at least one battery (not shown), etc., but the example embodiments are not limited thereto. Additionally, the computing device 2000 may further include one or more sensors 350, such as proximity sensors (e.g., an infra-red proximity sensor, a capacitive proximity sensor, etc.), location sensors (e.g., GPS, GLONASS, Beidou, Galileo, etc.), other sensors (e.g., thermometers, humidity sensors, pressure sensors, motion sensors, accelerometers, etc.), actuators, etc. Additionally, the I/O device 2500, etc., of the computing device 2000 may be optional.

In at least one example embodiment, the processing circuitry 2100 may include at least one processor (and/or processor cores, distributed processors, networked processors, etc.), which may be configured to control one or more elements of the computing device 2000 and/or control one or more elements of the associated power generator 120 and/or ESS 130, etc., and thereby cause the computing device 2000 to perform various operations related to the machine-learning model 110A, the power generator 120, and/or the ESS 130, etc. The processing circuitry 2100 is configured to execute processes by retrieving special purpose program code (e.g., special purpose computer readable instructions) and data from the memory 2300 to process them, thereby executing special purpose control and functions of the entire computing device 2000, such as the special purpose machine-learning model operations, the special purpose power generator operations, and/or the special purpose ESS operations associated with FIGS. 3 to 4B, etc., but is not limited thereto. Once the special purpose program instructions are loaded into the processing circuitry 2100, the processing circuitry 2100 executes the special purpose program instructions, thereby transforming the processing circuitry 2100 into special purpose processing circuitry.

In at least one example embodiment, the memory 2300 may be a non-transitory computer-readable storage medium and may include a random access memory (RAM), a read only memory (ROM), and/or a permanent mass storage device such as a disk drive, and/or a solid state drive, etc. Stored in the memory 2300 is special purpose program code (i.e., special purpose computer readable instructions) related to operating the machine-learning model 110A, power generator 120, and/or the ESS 130, etc., such as the methods discussed in connection with FIGS. 3 to 4B, etc. Such software elements may be loaded from a non-transitory computer-readable storage medium independent of the memory 2300, using a drive mechanism (not shown) connected to the computing device 2000, or via the network interface 2400, etc. Additionally, the memory 2300 may store configuration information, such as system information, operations related to the training of the machine-learning model 110A, operations related to the energy forecasting functions of the machine-learning model 110A, energy production instructions for the power generator 120, energy storage instructions for the ESS 130, energy transmission instructions for the power generator 120 and/or the ESS 130, etc., but the example embodiments are not limited thereto.

In at least one example embodiment, the at least one communication bus 2200 may enable communication and data transmission/reception to be performed between elements of the computing device 2000, and/or monitor the status of the elements of the computing device 2000 and/or the associated energy forecasting server 110, power generator 120, and/or ESS 130, etc., (e.g., monitor the operation of the machine-learning model 110A, monitor the energy production levels, monitor energy storage levels, monitor energy transmission levels, etc.). The bus 2200 may be implemented using a high-speed serial bus, a parallel bus, and/or any other appropriate communication technology. According to at least one example embodiment, the computing device 2000 may include a plurality of communication buses (not shown), such as an address bus, a data bus, etc.

The computing device 2000 may also include at least one network interface 2400, but is not limited thereto. The network interface 2400 may include at least one wireless transceiver which may be used to transmit and/or receive wireless signals in accordance with at least one desired radio access technology, such as 4G LTE, 5G NR, 6G, Wi-Fi, Bluetooth, UWB, etc. For example, the computing device 2000 may communicate with a core network (e.g., backend network, backhaul network, backbone network, data network, or another network) of a wireless communication network and/or a data network via the network interface 2400. Additionally, or alternatively, the network interface 2400 may be a wired network interface and may enable the computing device 2000 to communicate and/or transmit data to and from to network devices on the backend network, such as a core network gateway (not illustrated), a data network (not illustrated), such as the Internet, intranets, wide area networks, telephone networks, and/or VoIP networks, etc.

While FIG. 2 depicts an example embodiment of a computing device 2000 which may operate as a server, the example embodiments are not limited thereto, and may include additional and/or alternative architectures that may be suitable for the purposes demonstrated.

FIG. 3 is a flowchart depicting an example method of operating an energy forecasting machine-learning model according to at least one example embodiment. At least one operation illustrated in FIG. 3 may be executed by and/or performed using processing circuitry (not shown) of an energy forecasting server, such as the energy forecasting server 110 of FIG. 1, which may execute a machine-learning model, such as the machine-learning model 110A of FIG. 1, but the example embodiments are not limited thereto, and for example, the machine-learning model 110A may be executed by processing circuitry included in the power generator 120 and/or processing circuitry included in the ESS 130, etc. Additionally, while the operations of FIG. 3 will be discussed in terms of predicting future energy prices for a desired future time period using the energy forecasting machine-learning model, the example embodiments are not limited thereto and other energy-related forecasts may be calculated, for example, future energy demand levels, future energy production levels, etc., using similar operations.

In operation S3010, the processing circuitry may receive market data from one or more external sources, such as an energy marketplace, a public utility company, a government agency, a private energy generator, etc., but is not limited thereto. The market data may include historical energy data corresponding to at least one desired historical time period (e.g., a past time period, etc.), such as historical system-level demand forecasts, historical zonal demand forecasts, historical actual energy prices, historical predicted energy prices (e.g., energy prices previously predicted by the energy forecasting machine-learning model 110A for the same time period as the historical actual energy prices, etc.), historical zonal weather forecasts, historical system-level renewable energy production forecasts, historical system-level fossil fuel based energy production forecasts, historical net load information (e.g., a difference between system-level energy demand and the system-level energy generation level, etc.), historical zonal weather forecast information (e.g., including the historical apparent temperature, etc.), historical persistence term information (e.g., energy prices of the day before the desired historical time period, etc.), historical seasonality information, but is not limited thereto. According to some example embodiments, the desired historical time period may be a desired past hourly time period, a desired past day time period, a desired past weekly time period, a desired past monthly time period, a desired past quarterly time period, etc., but is not limited thereto. For example, the desired historical time period may include historical data covering several months of data to several years of data, but is not limited thereto.

Additionally, the processing circuitry may receive future and/or predicted energy data corresponding to a future time period, such as an hour ahead of a current time, a day ahead of a current day, a week ahead of a current week, a month ahead, a quarter ahead, a year ahead, etc., but the example embodiments are not limited thereto. The future energy data may include one or more of future system-level demand forecasts, future zonal demand forecasts, future zonal weather forecasts, future system-level renewable energy production forecasts, future system-level fossil-fuel-based energy production forecasts, predicted net load information, future zonal weather forecast information, future seasonality information, etc. However, the example embodiments are not limited thereto, and for example, the future energy data may be omitted.

In operation S3020, the processing circuitry may perform data preprocessing on the received historical energy data and/or received future energy data. More specifically, the processing circuitry may preprocess and/or format the received data into a format compatible with the energy forecasting machine-learning model.

In operation S3030, the processing circuitry may input the formatted data to the machine-learning model and operate the machine-learning model in a desired mode. More specifically, the machine-learning model may be operated in a training mode or a prediction mode, but is not limited thereto, and for example, the machine-learning model may operate in both modes simultaneously.

With respect to the training mode, in operation S3040, the processing circuitry may iteratively and/or sequentially determine and/or update weights and/or parameters associated with the machine-learning model based on the received historical energy data so that the summation of a squared error and/or a correlation error of the energy predictions generated by the machine-learning model are decreased and/or minimized. According to at least one example embodiment, the machine-learning model may be a gradient-boosted decision tree (GBDT), such as LightGBM, XGBoost, GBM, etc., and may calculate a customized correlation-enhanced objective function as shown below:

$$L = {α}_{q} {\sum }_{i} {\vert {e}_{i} \vert}^{p} + {α}_{q} {α}_{c} {\sum }_{i} {α}_{v} {\vert {e}_{i} \vert}^{p} , \qquad [ Equation 1 ]$$

wherein L is the objective (loss) function that the machine-learning model is decreasing and/or minimizing; eᵢ is an error term defined as the difference between the actual energy price (yᵢ) and a forecasted energy price (ŷᵢ) for a desired historical time period, e.g., eᵢ=yᵢ-ŷᵢ; α_{q} is set to 1 for deterministic forecasting or 2 (1−q) or 2q if performing quantile regression, where q represents the quantile uncertainty upper bound if q>0.5 or the quantile uncertainty lower bound if q<0.5; αᵥ indicates the degree of penalty added to the loss function, e.g., αᵥ is set to 0 if the forecast and the actual data both increase/decrease/remain the same for the same time instance, if one remains the same and the other increases or decreases αᵥ is set to 1, and αᵥ is set to 2 if the direction of the two are in opposite directions (e.g., the forecast indicates energy prices would increase but the actual energy price decreased, etc.); α_{c} is a hyperparameter determining the relative magnitude of the correlation error to the regression error and typically has a range from 0.5 to 2; and p is the power of the error term, e.g., if the machine-learning model is using squared errors, p=2, but is not limited thereto.

More specifically, the first term on the right-hand side of Equation 1 corresponds to a regression error of the predictions of the machine-learning model and the second term on the right-hand side of Equation 1 corresponds to a correlation error of the predictions of the machine-learning model. The regression error and the correlation error are multiplied by α_{q} whose value is based on a forecasted quantile (q), wherein an α_{q} value of 1 is used for deterministic models, but the example embodiments are not limited thereto. The penalty value of αᵥ may be determined based on whether the direction of the predicted energy price corresponding to a desired historical time period matches the actual energy price of the desired historical time period. If the predicted energy price matches the actual energy price, e.g., both prices increased, decreased, or remained the same for the same time period, then the αᵥ=0. If the directions of the predicted energy price and the actual energy prices moved in opposite directions, e.g., the predicted energy price was predicted to increase while the actual energy price decreased or vice versa, the penalty value αᵥ=2. If the direction of one of the predicted energy price and the actual energy price moved in one direction (either increased or decreased) and the other energy price remained the same, the penalty value αᵥ=1. The value of a, regularizes the relative magnitude of the correlation error to the regression error, and may be set based on an iterative tuning and/or training process for the machine-learning model, and for example, may be set to a range of 0 to 3.

More specifically, in operation S3041, the machine-learning model may determine the directional change of the predicted forecast, e.g., the predicted energy price forecast, and the actual and/or observed value, e.g., the actual energy price for the desired time period, which determines the value of αᵥ for each time instance (e.g., each data point). In operation S3042, the machine-learning model may scale the correlation error (e.g., the entire second term on the right-hand side of Equation 1) based on the square of the error magnitude, e.g., square of the difference in the predicted energy forecast and the actual energy data, such as the difference in the predicted energy price forecast and the actual energy price for the desired historical time period, etc.

In operation S3043, the machine-learning model may determine a correlation penalty, e.g., the second term on the right-hand side of Equation 1, based on the determined directional change and the determined correlation error. For example, if the desired historical time period is 08:00 AM of the previous day and the predicted energy price forecast was predicting that the energy price would increase, but in reality, the actual energy price decreased, the penalty value αᵥ may be set to 2, etc. As another example, if the predicted energy price forecast was predicting that the energy price would increase, but in reality, the actual energy price remained the same, the penalty value αᵥ may be set to 1, etc. As another example, if the predicted energy price forecast was predicting that the energy price would increase, but in reality, the actual energy price increased, the penalty value αᵥ may be set to 0, etc. Thus, the machine-learning model is not penalized when it correctly predicts the directional change in the desired predicted energy value, e.g., the predicted energy price, and is penalized if it incorrectly predicts the directional change in the desired predicted energy value. Further, the correlation error is scaled by the square of the magnitude of the error in the desired predicted energy value, thereby causing the machine-learning model to iteratively decrease and/or minimize the summation of the squared error and the correlation error of its energy predictions, namely, the objective (loss) function.

According to some example embodiments, the machine-learning model may perform a plurality of iterations of the machine-learning training process, e.g., repeating operation S3040, in order to decrease the summation of the squared error and the correlation error and thus improve its energy predictions. More specifically, the machine-learning model may adjust the values of the weights and/or adjustable parameters of the machine-learning model as well as adjust the relative importance of each of the data inputs received by the machine-learning model, such as the weather information, the energy demand information, the energy production information, the predicted energy price, the actual energy price, the persistence information, the seasonality information, etc.) of the machine-learning model, to further improve its energy predictions.

For example, if the output of the machine-learning model is a prediction of a future energy price for a desired future time period, the parameters of the machine-learning model may be the weight of the predicted energy demand for the desired future time period, the weight of the predicted temperature for the future time period, and the weight of the predicted power generation for the future time period, but the example embodiments are not limited thereto. The machine-learning model may perform multiple iterations to determine the weight to give to each of the parameters by comparing the difference between a predicted energy price and the actual energy price using Equation 1 as discussed above, for different values of the predicted energy demand, the predicted temperature, and the predicted power generation, to determine an improved and/or optimized weight to give to these parameters, thereby improving and/or optimizing the machine-learning model, but the example embodiments are not limited thereto.

Now returning to FIG. 3, if the machine-learning model is operating in a prediction mode, the processing circuitry may perform operation S3010 to S3030 as discussed above. However, the machine-learning model performs operation S3050 instead of operation S3040 and generates an energy prediction and/or energy forecast based on the historical energy data and the actual energy data. More specifically, in operation S3051, the machine-learning model may generate a deterministic energy forecast which includes a single energy prediction for a target variable (e.g., an energy price prediction, an energy demand prediction, an energy production prediction, etc.) for a desired time period, but is not limited thereto. For example, according to some example embodiments, the machine-learning model may generate short-term energy forecasts, e.g., energy predictions for the next hour, next day, next week, next month, etc. Additionally, the machine-learning model may generate long-term energy forecasts which cover, for example, several months to several years of predictions (e.g., long-term energy forecasting, long-term modeling, long-term revenue modeling, etc.), but is not limited thereto.

According to at least one example embodiment, the deterministic energy forecast may be the mean of forecasts for all quantiles for the target variable (e.g., the desired energy prediction and/or energy forecast, such as the future energy price, future energy demand, future energy production, etc.). In some example embodiments, the machine-learning model may generate a probabilistic energy forecast which quantifies the uncertainty of the energy forecast for the target variable by producing a range within which the target variable may fall within a given probability at any desired time period. The probabilistic energy forecast may also determine the probability of the target variable being over or under a desired value. In other example embodiments, the machine-learning model may generate a quantile regression energy forecast which models the relationship between a set of predictive parameters and the target variable within specified percentiles (e.g., quantiles), instead of forecasting the target variable's expected (e.g., mean or median) value.

Further, the machine-learning model may generate recommendations and/or instructions based on the energy forecast. For example, if the energy forecast includes a decrease in the predicted energy price at X hour, the machine-learning model may recommend and/or instruct a power generator to decrease the production of energy at X hour and/or decrease the transmission of power to the electricity grid at X hour, etc., and for an ESS, the machine-learning model may recommend and/or instruct the ESS to increase the amount of energy storage at X hour and/or to decrease the transmission of power to the electricity grid at X hour, etc., but the example embodiments are not limited thereto.

In operation S3060, the machine-learning model may output the generated energy forecast to a power generator and/or an ESS, including the recommendation and/or instructions, but the example embodiments are not limited thereto. Additionally, the machine-learning model may also output and/or store the generated energy forecast such that the generated energy forecast is used in a future iteration of the training process of the machine-learning model, etc.

FIGS. 4A to 4B are graphs illustrating the performance of various energy forecast prediction models versus actual energy data according to at least one example embodiment.

As shown in FIGS. 4A and 4B, the energy predictions made by a machine-learning model according to at least one example embodiment provides improved energy prediction over conventional squared regression error as loss function model, but the example embodiments are not limited thereto. The graphs illustrated in FIGS. 4A and 4B show energy prices from ERCOT over two different days during the summer of 2023. As shown in the 07-20 12:00 to 07-20 21:00 time period in FIG. 4A, the correlation-enhanced energy predictions of at least example embodiment more accurately predicted the timing and magnitude of the energy price spikes observed in the actual energy price graph than the conventional regression machine-learning model predictions. Additionally, in the 07-21 12:00 to 07-22 00:00 time period, while both the correlation-enhanced energy predictions of at least example embodiment and the conventional regression machine-learning model energy prediction overestimated the energy prices, the correlation-enhanced energy predications of at least example embodiment had less of an error than the conventional regression machine-learning model predictions as well as accurately predicted that the timing of the peaks and troughs of the actual energy prices.

Similarly, as shown in FIG. 4B, the correlation-enhanced energy predictions of at least example embodiment more accurately predicted the energy prices and the timing of peaks and troughs in the energy price than the conventional regression machine-learning model predictions. The Inventors have observed that the correlation-enhanced energy forecasting machine-learning model of at least one example embodiment reduces error and increases the correlation of directional changes over conventional energy prediction machine-learning models and provides performance increases of 83% to 85.5%.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A computing device comprising:
memory having computer readable instructions stored thereon; and
processing circuitry configured to execute the computer readable instructions to,
obtain historical energy data, the historical energy data including historical energy price data,
generate a correlation-enhanced energy forecast using a machine learning model based on the historical energy data,
output energy storage recommendation information corresponding to a desired future time period based on the correlation-enhanced energy forecast, the outputting of the energy storage recommendation information including adjusting energy storage levels of an energy storage system corresponding to the desired future time period based on the energy storage recommendation information, wherein
training of the machine learning model is performed based on a relative direction of a previous energy forecast corresponding to a previous time period and a relative direction of the historical energy data for the previous time period, the training of the machine learning model including,
determining, using the machine learning model, an energy price prediction error based on a previous energy price prediction for at least one historical time period and the historical energy price data for the at least one historical time period,
determining, using the machine learning model, a correlation error based on the energy price prediction error and the relative direction of the previous energy price prediction for the at least one historical time period and a relative direction of an actual energy price for the at least one historical time period, and
adjusting at least one weight or parameter of the machine learning model based on the energy price prediction error and the correlation error.

2. The computing device of claim 1, wherein the processing circuitry is further configured to execute the computer readable instructions to:
output the energy storage recommendation information to the energy storage system, the energy storage recommendation information including an energy price prediction corresponding to the desired future time period; and
increasing storage of energy in the energy storage system based on the energy price prediction and a desired price threshold.

3. The computing device of claim 1, wherein the processing circuitry is further configured to execute the computer readable instructions to:
output the energy storage recommendation information to a power generation system, the energy storage recommendation information instructing the power generation system to adjust energy production levels corresponding to the desired future time period.

4. The computing device of claim 1, wherein the historical energy data includes at least one of:
system-level energy demand forecast information, zonal-level energy demand forecast information, system-level renewable energy generation forecast, net load information, historical energy price information, zonal weather forecast information, persistence term information, seasonality information, or any combinations thereof.

5. The computing device of claim 1, wherein
the machine learning model is further configured to generate the correlation-enhanced energy forecast by,
forecasting future energy prices for the desired future time period based on the historical energy price data for the at least one historical time period.

6. (canceled)

7. The computing device of claim 1, wherein the processing circuitry is further configured to execute the computer readable instructions to:
train the machine learning model using a gradient-boosted decision tree algorithm.

8. A system comprising:
an energy storage system connected to an energy grid;
memory having computer readable instructions stored thereon; and
processing circuitry configured to execute the computer readable instructions to,
obtain historical energy data associated with the energy grid, the historical energy data including historical energy price data,
generate a correlation-enhanced energy forecast using a machine learning model based on the historical energy data,
determine energy storage recommendation information corresponding to a desired future time period based on the correlation-enhanced energy forecast, and
adjust energy storage levels of the energy storage system corresponding to the desired future time period based on the energy storage recommendation information,
wherein
training of the machine learning model is performed based on a relative direction of a previous energy forecast corresponding to a previous time period and a relative direction of the historical energy data for the previous time period, the training including,
determining an energy price prediction error based on a previous energy price prediction for at least one historical time period and the historical energy price data for the at least one historical time period,
determining a correlation error based on the energy price prediction error and the relative direction of the previous energy price prediction for the at least one historical time period and a relative direction of an actual energy price for the at least one historical time period, and
adjusting at least one weight or parameter of the machine learning model based on the energy price prediction error and the correlation error.

9. (canceled)

10. The system of claim 8, wherein
the energy storage recommendation information includes an energy price prediction corresponding to the desired future time period; and
the processing circuitry is further configured to execute the computer readable instructions to adjust the energy storage levels of the energy storage system by,
increasing output of energy from the energy storage system to the energy grid based on the energy price prediction and a desired price threshold.

11. The system of claim 10, wherein the processing circuitry is further configured to execute the computer readable instructions to adjust the energy storage levels of the energy storage system by:
increasing storage of energy in the energy storage system based on the energy price prediction and the desired price threshold.

12. The system of claim 8, further comprising:
a power generation system configured to generate energy; and
the processing circuitry is further configured to execute the computer readable instructions to,
adjust energy production levels of the power generation system corresponding to the desired future time period based on the energy storage recommendation information.

13. The system of claim 12, wherein
the energy storage recommendation information includes an energy price prediction corresponding to the desired future time period; and
the processing circuitry is further configured to execute the computer readable instructions to adjust the energy production levels of the power generation system by,
controlling the power generation system based on the energy price prediction and a desired price threshold such that the power generation system outputs the generated energy to the energy grid.

14. The system of claim 8, wherein the historical energy data includes at least one of:
system-level energy demand forecast information, zonal-level energy demand forecast information, system-level renewable energy generation forecast, net load information, historical energy price information, zonal weather forecast information, persistence term information, seasonality information, or any combinations thereof.

15. The system of claim 8, wherein
the machine learning model is further configured to generate the correlation-enhanced energy forecast by,
forecasting future energy prices for the desired future time period based on the historical energy price data for the at least one historical time period.

16. (canceled)

17. The system of claim 8, wherein the processing circuitry is further configured to execute the computer readable instructions to:
train the machine learning model using a gradient-boosted decision tree algorithm.

18. A method of operating a computing device, the method comprising:
obtaining historical energy data, the historical energy data including historical energy price data;
generating a correlation-enhanced energy forecast using a machine learning model based on the historical energy data; and
outputting energy storage recommendation information corresponding to a desired future time period based on the correlation-enhanced energy forecast, the outputting of the energy storage recommendation information including adjusting energy storage levels of an energy storage system corresponding to the desired future time period based on the energy storage recommendation information, wherein
training of the machine learning model is performed based on a relative direction of a previous energy forecast corresponding to a previous time period and a relative direction of the historical energy data for the previous time period, the training including,
determining an energy price prediction error based on a previous energy price prediction for at least one historical time period and the historical energy price data for the at least one historical time period,
determining a correlation error based on the energy price prediction error and the relative direction of the previous energy price prediction for the at least one historical time period and a relative direction of an actual energy price for the at least one historical time period, and
adjusting at least one weight or parameter of the machine learning model based on the energy price prediction error and the correlation error.

19. The method of claim 18, further comprising:
outputting the energy storage recommendation information to a power generation system, the energy storage recommendation information instructing the power generation system to adjust energy production levels corresponding to the desired future time period.

20. The method of claim 18, wherein
the generating the correlation-enhanced energy forecast includes,
forecasting future energy prices for the desired future time period based on the historical energy price data for the at least one historical time period.
